(19) United States
(12) Patent Application Publication
(10) Pub. No.: US 2009/0073320 A1
(43) Pub. Date: Mar. 19, 2009

(54) INFORMATION PROCESSING APPARATUS AND INFORMATION PROCESSING METHOD

(75) Inventors: Shin Todo, Tokyo (JP); Katsuakira Moriwake, Tadley (GB); Shigeru Akahane, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/191,686

(22) Filed: Aug. 14, 2008

(30) Foreign Application Priority Data
Sep. 14, 2007 (JP) 2007-239728

(51) Int. Cl. H04N 5/268

(52) U.S. Cl. 348/705; 348/E05.057

(57) ABSTRACT

Disclosed herein is an information processing apparatus causing a larger number of video signals than at least one video port possessed by a processor to be input to the processor through the video port, the information processing apparatus including: a multiplexed video frame creation section creating multiplexed video frames in such a manner that each of the multiplexed video frames has the video signals multiplexed therein for input to the processor through the video port and includes a sufficiently large number of pixels so that frame images represented individually by the video signals may be pasted onto each multiplexed video frame in non-overlapping relation to one another; and a multiplexing block multiplexing the video signals in such a manner that the frame images represented individually by the video signals are pasted in non-overlapping relation to one another onto each of the multiplexed video frames created by the multiplexed video frame creation section.

### CROSS REFERENCES TO RELATED APPLICATIONS

The present invention contains subject matter related to Japanese Patent Application JP 2007-239728 filed with the Japan Patent Office on Sep. 14, 2007, the entire contents of which being incorporated herein by reference.

### BACKGROUND OF THE INVENTION

1. Field of the Invention

The present invention relates to an information processing apparatus and an information processing method. More particularly, the invention relates to an information processing apparatus and an information processing method for reducing with ease the number of transmission streams for sending a plurality of video signals.

2. Description of the Related Art

Heretofore, it has been customary for CPUs (central processing units) and DSPs (digital signal processors) to employ, as their external input/output formats, unidirectional address and control signal lines for sending addresses and control signals from the controlling side to the controlled side in combination with a bidirectional data line for exchanging data therebetween, or a unidirectional signal line for sending control signals from the controlling side to the controlled side as well as a bidirectional address/data multiplexing line for exchanging addresses and data therebetween.

Recent years have witnessed a growing number of processors each equipped with a video interface input/output port in keeping with the ongoing trend toward higher processor performance and widening use of application-specific SOCs (systems on chips). These processors include media processors, GPUs (graphics processing units), and video-oriented DSPs.

The video interface, sometimes called the parallel video interface, represents unidirectional transmission formats in which are transmitted timing signals such as clock signals, horizontal and vertical synchronizing signals as well as video and audio data. In some video format variations, the information to be transmitted may include a field identification signal and a data enable signal. One such video format involves multiplexing onto the data line the timing signals such as those acting as flags and stipulated under SMPTE (Society of Motion Picture and Television Engineers) 125M or SMPTE 274M. A set of the input and output pins constituting such a video interface is called the video port.

The bandwidth of the video port installed in the above-mentioned chips is being rapidly expanded to meet some of the recent technical developments. They include the display resolution getting improved continuously, a shift in broadcast image quality from standard quality (720×480) to high-definition quality (1920×1080), and the diversifying display capabilities of TV sets (480i/480p/1080i/720p/1080p).

With varieties of video formats coming to the fore, it has become necessary for the chips to incorporate a video interface capable of supporting a plurality of video formats.

For example, some household digital recorders are equipped with a video output that does not include menus or guides, apart from a monitor output that includes menus and guides. Other home-use digital recorders incorporate a decoder output that decodes bit streams coming from the antenna.

In some cases, broadcasting and business-use equipment may be required concurrently to provide a plurality of video outputs: the standard video output (program output and video output), a monitor output that outputs superimposed images, a preview output that outputs images given a few seconds ago, a display screen output connected to an external display device, and a display output feed to a display device of the equipment.

Too often, the above-mentioned video data outputs are not unified in format. They come with diverse combinations of specifications covering SD (standard-definition) image quality, HD (high-definition) image quality, external display sizes, internal display sizes, frame frequencies (refresh rates), and interlace and progressive scanning options.

Broadcasting and business-use apparatuses need to deal with further technical challenges in video format diversity. That is, numerous images need to be processed simultaneously; video signals of different formats need to be input; and sometimes images from PCs (personal computers) need to be admitted.

In order to construct such apparatuses simply, it is preferable for each apparatus to utilize a high-performance processor for image processing and to have the above-mentioned input/output signals connected directly to the processor. The input to and the output from the processor in each of these apparatuses are thus required to address multiple screens and multiple formats.

Normally, one video port is designed to handle one video input or output. The simplest way to address multiple screens and multiple formats is by installing as many video ports as the number of multiple screens and formats involved. However, because each port has numerous pins, an offhand increase in the number of video ports would result in an inordinately large number of pins to accommodate. On the semiconductor chip, a larger pin count will lead to a substantially larger package size which in turn will result in higher costs of manufacturing.

Several methods have been proposed to bypass the bottleneck above. One such method, disclosed in Japanese Patent Laid-Open No. 2006-236056, involves sharing a single port among a plurality of video formats on a time-sharing basis.

### SUMMARY OF THE INVENTION

Video formats are getting diversified all the time as mentioned above, and they must be dealt with somehow by the port. The proposed time-sharing scheme could fall short of enabling the port to keep up with the ever-increasing video formats. Furthermore, the time-sharing scheme requires rigorous timing management that involves complicated control processes. That in turn would result in an appreciably longer processing time and higher costs.

The present invention has been made in view of the above circumstances and provides arrangements such that a plurality of streams of video signals are multiplexed into a single video format before being fed to a downstream processing block and that a multiplexed video signal containing a plurality of video signals is demultiplexed through extraction into the separate video signals before being sent separately to different downstream blocks, whereby the number of video signal transmission streams is reduced easily.

In carrying out the present invention and according to a first embodiment thereof, there is provided an information processing apparatus causing a larger number of video signals than at least one video port possessed by a processor to be input to the processor through the video port. The information processing apparatus includes multiplexed video frame creation means for creating multiplexed video frames in such a manner that each of the multiplexed video frames has the video signals multiplexed for input to the processor through the video port and includes a sufficiently large number of pixels so that frame images represented individually by the video signals may be pasted onto each multiplexed video frame in non-overlapping relation to one another. The information processing apparatus further includes multiplexing means for multiplexing the video signals in such a manner that the frame images represented individually by the video signals are pasted in non-overlapping relation to one another onto each of the multiplexed video frames created by the multiplexed video frame creation means.

According to a second embodiment of the present invention, there is provided an information processing method for use with an information processing apparatus for causing a larger number of video signals than at least one video port possessed by a processor to be input to the processor through the video port. The information processing method includes the steps of: creating multiplexed video frames in such a manner that each of the multiplexed video frames has the video signals multiplexed for input to the processor through the video port and includes a sufficiently large number of pixels so that frame images represented individually by the video signals may be pasted onto each multiplexed video frame in non-overlapping relation to one another; and

multiplexing the video signals in such a manner that the frame images represented individually by the video signals are pasted in non-overlapping relation to one another onto each of the multiplexed video frames created in the multiplexed video frame creating step.

According to a third embodiment of the present invention, there is provided an information processing apparatus causing a larger number of video signals than at least one video port possessed by a processor to be output from the processor through the video port. The information processing apparatus includes: acquisition means for acquiring a multiplexed video signal which is output by the processor through the video port and which has the video signals multiplexed; and extraction means for extracting individually frame images of the video signals from a frame image which is constituted by the multiplexed video signal acquired by the acquisition means and which has a sufficiently large number of pixels so that the frame images of the video signals are being pasted on the frame image in non-overlapping relation to one another.

According to a fourth embodiment of the present invention, there is provided an information processing method for use with an information processing apparatus for causing a larger number of video signals than at least one video port possessed by a processor to be output from the processor through the video port. The information processing method includes the steps of:

acquiring a multiplexed video signal which is output by the processor through the video port and which has the video signals multiplexed; and extracting individually frame images of the video signals from a frame image which is constituted by the multiplexed video signal acquired in the acquiring step and which has a sufficiently large number of pixels so that the frame images of the video signals are being pasted on the frame image in non-overlapping relation to one another.

According to the first and the second embodiments of the present invention outlined above, multiplexed video frames are first created, with each frame having a sufficiently large number of pixels so that the frame images of a plurality of video signals may be pasted onto the frame in non-overlapping relation to one another. The frame images of the video signals are then pasted in non-overlapping relation to one another onto each of the multiplexed video frames thus created, whereby the video signals are multiplexed.

According to the third and the fourth embodiments of the present invention outlined above, a multiplexed video signal having a plurality of video signals multiplexed therein is output by the processor through the video port and acquired. From a frame image which is constituted by the multiplexed video signal thus acquired and which has a sufficiently large number of pixels so that the frame images of the video signals are being pasted thereon in non-overlapping relation to one another, the pasted frame images are individually extracted therefrom.

Where the embodiments of the present invention are in use, video signals may be transmitted, especially through a smaller number of transmission streams than before. The invention embodied as outlined above helps reduce the manufacturing cost of systems for handling video signals.

### BRIEF DESCRIPTION OF THE DRAWINGS

Further objects and advantages of the present invention will become apparent upon a reading of the following description and appended drawings in which:

FIG. 1 is a block diagram showing a typical configuration of an image processing system embodying the present invention;

FIGS. 2A and 2B are schematic views depicting a typical video interface and typical waveforms of video signals transmitted through the video interface;

FIG. 3 is a schematic view explanatory of the image of a video signal being a high-definition (HD) image;

FIG. 4 is a schematic view showing a detailed structure of a multiplexing block;

FIG. 5 is a schematic view showing a more detailed structure of a multiplexing unit;

FIG. 6 is a schematic view showing a detailed structure of an extraction block;

FIG. 7 is a schematic view showing a more detailed structure of a demultiplexing unit;

FIG. 8 is a flowchart of steps constituting a frame image reception process;

FIG. 9 is a flowchart of steps constituting a multiplexing process;

FIG. 10 is a flowchart of steps constituting an extraction process;

FIG. 11 is a flowchart of steps constituting a frame image output process;

FIG. 12 is a block diagram showing a typical configuration of another image processing system embodying the present invention;

FIG. 13 is a schematic view showing a typical structure of another multiplexing block;

FIG. 14 is a schematic view showing a typical structure of another extraction block;

FIG. 15 is a block diagram showing a typical configuration of a further image processing system embodying the present invention;

FIG. 16 is a schematic view showing a typical structure of a further multiplexing block;

FIG. 17 is a schematic view showing a typical structure of a further extraction block; and

FIG. 18 is a block diagram showing a typical structure of a personal computer embodying the present invention.

### DETAILED DESCRIPTION OF THE PREFERRED EMBODIMENTS

Preferred embodiments of the present invention will now be described in reference to the accompanying drawings.

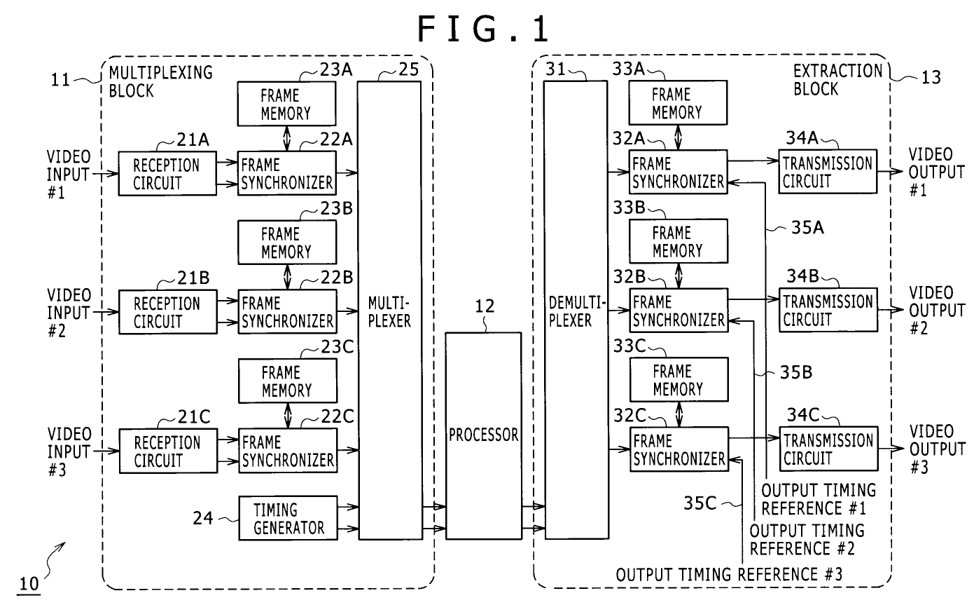

FIG. 1 is a block diagram showing a typical configuration of an image processing system 10 embodying the present invention.

The image processing system 10 includes a video port based on a three-stream video interface. The system 10 performs image processing on video data that are input in three streams (video input #1, video input #2, video input #3), and outputs the processed video data in three streams (video output #1, video output #2, video output #3).

The video interface represents unidirectional transmission formats in which timing signals such as a clock signal, a horizontal synchronizing signal and a vertical synchronizing signal are transmitted, along with video and audio data. This type of video interface may also be called the parallel video interface. Depending on the video format variation in use, the information to be transmitted may include a field identification signal and a data enable signal. The video port provides the input and output terminals that make up the video interface.

The formats of the video data (e.g., resolution, frame rate, scanning scheme, transmission system, and compression standard) input and output through each of the streams of the video port are independent of one another. These formats may be either the same or different between the streams. In the description that follows, video data are assumed to be input and output in different video formats between the streams.

The image processing system 10 includes a multiplexing block 11, a processor 12, and an extraction block 13. The multiplexing block 11 multiplexes the video data input through the three streams into one video data sequence. The processor 12 performs image processing on the video data. The extraction block 13 individually extracts three video data sequences from the multiplexed video data and outputs the extracted data through the different streams.

The multiplexing block 11 has a reception circuit 21A, a frame synchronizer 22A, and a frame memory 23A furnished for the video input #1; a reception circuit 21B, a frame synchronizer 22B, and a frame memory 23B provided for the video input #2; and a reception circuit 21C, a frame synchronizer 22C, and a frame memory 23C installed for the video input #3.

The reception circuits 21A through 21C each include a cable equalizer, a deserializer, decoders, a 4:2:2/4:4:4 coder, and an A/D (analog-to-digital) converter. Using these components, each reception circuit arranges each input video signal into a video format constituted by a synchronizing signal (Input Sync), a data signal (Input Data), and a clock signal (Input CK). In the ensuing description, the reception circuits 21A through 21C will be simply referred to as the reception circuit 21 if there is no specific need to distinguish therebetween.

The frame synchronizers 22A through 22C each synchronize the frame timings of a plurality of video signals as they are being multiplexed. The frame synchronizer 22A causes the frame memory 23A having a storage area for temporarily accommodating a video signal to hold a video signal of one frame (frame data) fed from the reception circuit 21A. In response to a request from a multiplexer 25, the frame synchronizer 22A reads the frame data from the frame memory 23A and supplies the read frame data to the multiplexer 25. The frame synchronizer 22B causes the frame memory 23B having a storage area for temporarily accommodating a video signal to hold a video signal of one frame (frame data) fed from the reception circuit 21B. In response to a request from the multiplexer 25, the frame synchronizer 22B reads the frame data from the frame memory 23B and supplies the read frame data to the multiplexer 25. The frame synchronizer 22C causes the frame memory 23C having a storage area for temporarily accommodating a video signal to hold a video signal of one frame (frame data) fed from the reception circuit 21C. In response to a request from the multiplexer 25, the frame synchronizer 22C reads the frame data from the frame memory 23C and supplies the read frame data to the multiplexer 25. In the description that follows, the frame synchronizers 22A through 22C will be simply referred to as the frame synchronizer if there is no specific need to distinguish therebetween.

The frame memories 23A through 23C are each composed of a semiconductor memory or the like and provide a storage area large enough to hold a video signal of at least one frame. The frame memories 23A through 23C accommodate the frame data fed from the frame synchronizers 22A through 22C respectively, and supply the retained frame data to the frame synchronizers when so requested by the latter. In the ensuing description, the frame memories 23A through 23C will be simply referred to as the frame memory 23 if there is no specific need to distinguish therebetween.

The multiplexing block 11 also includes a timing generator 24 as well as the multiplexer 25. The timing generator 24 is a frequency multiplier that has an oscillator and a PLL (phase locked loop) circuit. Using these components, the multiplexing block 11 creates a video signal (called a multiplexed video signal) into which to multiplex the video signals input through the different streams of the block 11 in such a manner that the bandwidth of the video input port of the processor 12 is not exceeded. The multiplexed video signal is supplied to the multiplexer 25.

The multiplexed video signal is made up of a synchronizing signal (Mux Sync), a data signal (Mux Data), and a clock signal (Mux CK). The frame data in the multiplexed video signal is called a multiplexed video frame. The image in the multiplexed video frame is blank. That is, the multiplexed video signal is a signal of which only the frame is designated in keeping with a predetermined video format. The multiplexed video signal has its multiplexed video frame pasted with frame data of the video signals that have been input through the different streams. The screen size of the multiplexed video frame is larger than the sum of the screen sizes of the frame data from the video signals of the different streams. The frame data of the different video signals are pasted onto the multiplexed video frame in non-overlapping relation to one another. It should be noted that as mentioned above, the bandwidth of the multiplexed video signal is kept from exceeding the bandwidth of the video input port of the processor 12 (which means that the bandwidth of the multiplexed video signal is narrower than the bandwidth of the video input port of the processor 12).

The multiplexer (MUX) 25 pastes (i.e., embeds) the frame data of the video signals from the different streams onto the frame data of the multiplexed video signal sent from the timing generator 24. Following the multiplexing process, the multiplexer 25 supplies the processor 12 with the multiplexed video signal (of one stream) having the video signals of the different streams multiplexed therein.

The processor 12 performs relevant processes on the images of the video signals embedded in the multiplexed video signal that was input through one video port. At this point, the processor 12 may either carry out its processing on the frame data as embedded in the input multiplexed video signal or extract the video signals from the input multiplexed video signal before processing the extracted frame data.

After the image processing, the processor 12 outputs the processed multiplexed video signal through one video port to the extraction block 13 (as a single-stream video signal). Where the video signals were extracted from the multiplexed signal for the image processing, the processor 12 again multiplexes the processed video signals into a multiplexed video signal which is then output.

The extraction block 13 includes a demultiplexer 31. In operation, the demultiplexer 31 extracts the video signals embedded (i.e., multiplexed) in the multiplexed video signal coming from the processor 12. The extracted video signals are sent to the frame synchronizers 32A through 32C whereby the video signals are separated into different streams.

Frame synchronizers 32A through 32C control the output timings of the video signals (frame data) fed from the demultiplexer 31. The frame synchronizer 32A causes a frame memory 33A to hold temporarily the video signal (frame data) sent from the demultiplexer 31. Based on an output timing reference signal #1 which is supplied on a signal line 35A and which serves as a control signal for output timing control, the frame synchronizer 32A reads the frame data from the frame memory 33A and forwards the read frame data to a transmission circuit 34A. The frame synchronizer 32B causes a frame memory 33B to hold temporarily the video signal (frame data) sent from the demultiplexer 31. Based on an output timing reference signal #2 which is supplied on a signal line 35B and which serves as a control signal for output timing control, the frame synchronizer 32B reads the frame data from the frame memory 33B and forwards the read frame data to a transmission circuit 34B. The frame synchronizer 32C causes a frame memory 33C to hold temporarily the video signal (frame data) sent from the demultiplexer 31. Based on an output timing reference signal #3 which is supplied on a signal line 35C and which serves as the control signal for output timing control, the frame synchronizer 32C reads the frame data from the frame memory 33C and forwards the read frame data to a transmission circuit 34C. In the description that follows, the frame synchronizers 32A through 32C will be simply referred to as the frame synchronizer 32 if there is no specific need to distinguish therebetween.

The frame memories 33A through 33C are each composed of a semiconductor memory or the like and provide a storage area large enough to accommodate a video signal of at least one frame. The frame memories 33A through 33C hold the frame data supplied by the frame synchronizers 32A through 32C respectively. In response to requests from the frame synchronizers 32A through 32C, the frame memories 33A through 33C supply the frame data they hold to the requesting synchronizers. In the ensuing description, the frame memories 33A through 33C will be simply referred to as the frame memory 33 if there is no specific need to distinguish therebetween.

The transmission circuits 34A through 34C each include a cable driver, a serializer, encoders, a 4:2:2/4:4:4 converter, and a D/A (digital-to-analog) converter. The transmission circuit 34A converts into a predetermined physical format the video signals coming from the frame synchronizer 32A, and transmits the result of the conversion as a video output #1 outside the image processing system 10. The transmission circuit 34B converts into a predetermined physical format the video signals coming from the frame synchronizer 32B, and transmits the result of the conversion as a video output #2 outside the image processing system 10. The transmission circuit 34C converts into a predetermined physical format the video signals coming from the frame synchronizer 32C, and transmits the result of the conversion as a video output #3 outside the image processing system 10. In the ensuing description, the transmission circuits 34A through 34C will be simply referred to as the transmission circuit 34 if there is no specific need to distinguish therebetween.

In the foregoing description, the image processing system 10 was shown to have the three-stream video port (with input and output terminals). However, this is not limitative of the present invention. Alternatively, the image processing system 10 may be furnished with any number of video ports (and streams). The multiplexing block 11 multiplexes the video signals of the different streams into a single-stream multiplexed video signal for output to the processor 12. The extraction block 13 extracts the video signals included in the multiplexed video signal that was output by the processor 12 as one stream, and sends the extracted video signals of the different streams outside the image processing system 10.

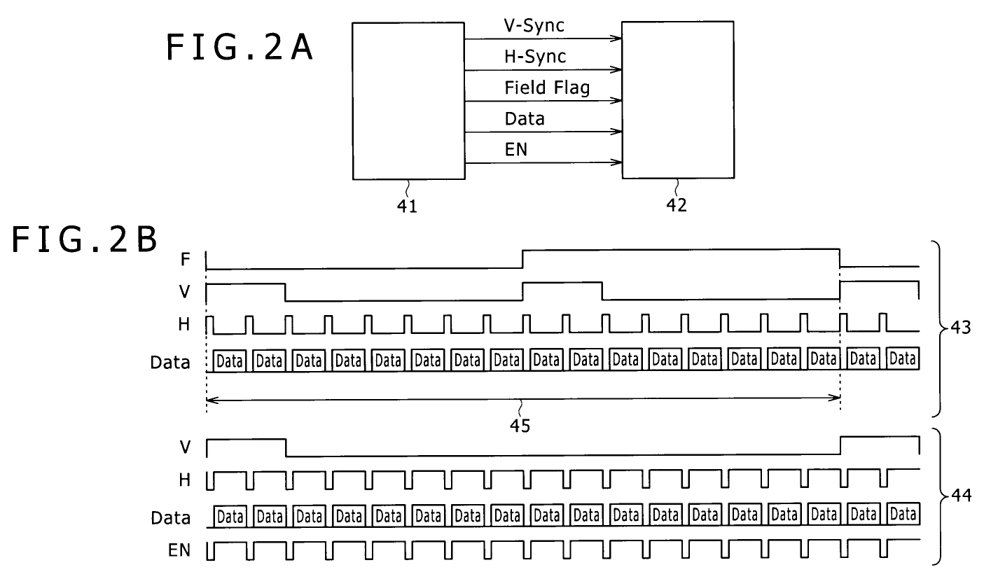

FIG. 2A is a schematic view depicting a typical video interface. Through the video interface, as shown in FIG. 2A, a horizontal synchronizing signal (H-Sync), a vertical synchronizing signal (V-Sync), a field flag signal (Field Flag) indicating either a first field or a second field, a data signal (Data) composed of video and audio data, and an enable signal (EN) representing a clock are sent from a source processing section 41 to a destination processing section 42. That is, there exist a plurality of synchronizing signals (Sync) including the horizontal synchronizing signal, vertical synchronizing signal, and field flag signal.

FIG. 2B illustrates typical waveforms of the video signal transmitted through the video interface of FIG. 2A. A range 43 in FIG. 2B indicates the waveforms of an interlace scan video signal, and a range 44 in FIG. 2B shows the waveforms of a progressive scan video signal.

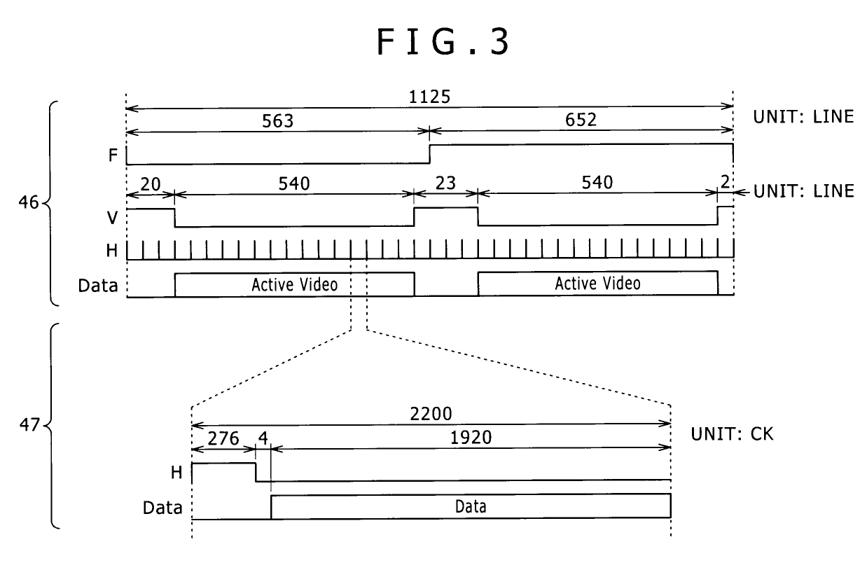

Of the waveforms in the range 43 of FIG. 2B, those indicated by a bidirectional arrow 45 are shown detailed in FIG. 3. FIG. 3 is a schematic view explanatory of the image of the video signal being a high-definition (HD) image.

As shown in a range 46 of FIG. 3, data of one field is transmitted in 540 lines during one cycle of the vertical synchronizing signal (V). During one cycle of the horizontal synchronizing signal (H), data of one line (1920 pixels) is transmitted as indicated in a range 47 of FIG. 3.

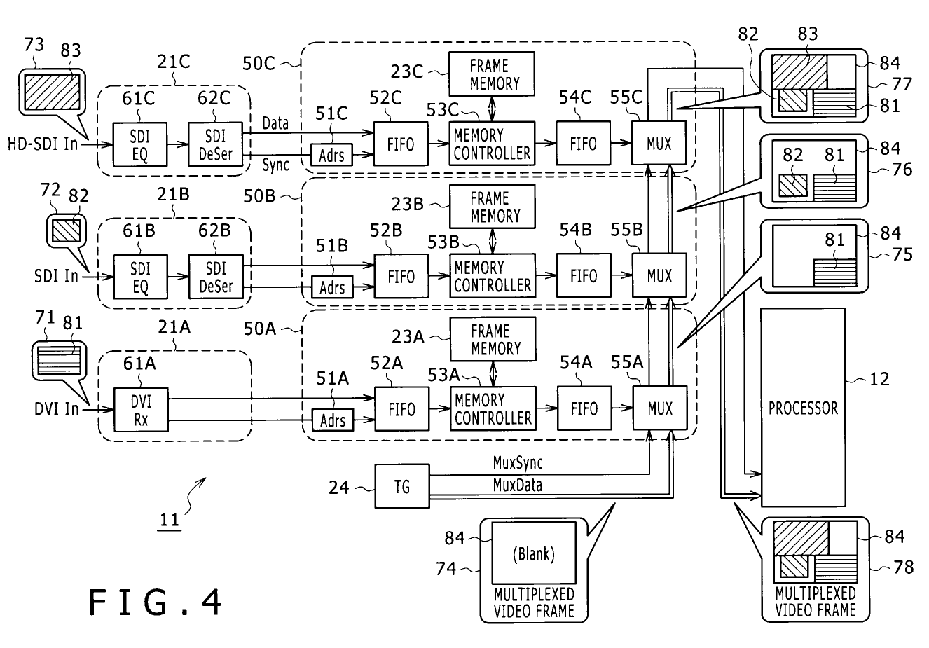

FIG. 4 shows a detailed structure of the multiplexing block 11 in FIG. 1. In FIG. 4, the internal structure of the multiplexing block 11 is shown vertically reversed with regard to FIG. 1. That is, the video input #1 is shown below whereas the video input #3 is indicated above in FIG. 4.

As depicted in FIG. 4, the multiplexer 25 in FIG. 1 may be constituted by a plurality of multiplexing (MUX) units for individually multiplexing video signals onto the multiplexed video signal. Under this scheme, a multiplexing unit of the same structure may be used for each of the streams involved.

A multiplexing unit 50A is configured to multiplex the video input #1. In operation, the multiplexing unit 50A receives the video signal from the reception circuit 21A and pastes the frame data of the received signal onto the frame of the multiplexed video signal at appropriate coordinates (for multiplexing). In addition to the frame memory 23A, the multiplexing unit 50A includes an address section (Adrs) 51A for creating address information based on synchronizing signals; an FIFO (first-in first-out) memory 52A acting as a cache memory from which data is read on a first-in, first-out basis; a memory controller 53A for writing and reading data to and from the frame memory 23A; another FIFO memory 54A; and a multiplexer (MUX) 55A for multiplexing the video signal of the video input #1 onto the multiplexed video signal. In other words, the components ranging from the address section 51A to the FIFO memory 54A correspond to those of the frame synchronizer 22A in FIG. 1.

A multiplexing unit 50B is configured to multiplex the video input #2. In operation, the multiplexing unit 50B receives the video signal from the reception circuit 21B and pastes the frame data of the received signal onto the frame of the multiplexed video signal at appropriate coordinates (for multiplexing). In addition to the frame memory 23B, the multiplexing unit 50B includes an address section (Adrs) 51B for creating address information based on synchronizing signals; an FIFO (first-in first-out) memory 52B; a memory controller 53B for writing and reading data to and from the frame memory 23B; another FIFO memory 54B; and a multiplexer (MUX) 55B for multiplexing the video signal of the video input #2 onto the multiplexed video signal. In other words, the components ranging from the address section 51B to the FIFO memory 54B correspond to those of the frame synchronizer 22B in FIG. 1.

A multiplexing unit 50C is configured to multiplex the video input #3. In operation, the multiplexing unit 50C receives the video signal from the reception circuit 21C and pastes the frame data of the received signal onto the frame of the multiplexed video signal at appropriate coordinates (for multiplexing). In addition to the frame memory 23C, the multiplexing unit 50C includes an address section (Adrs) 51C for creating address information based on synchronizing signals; an FIFO (first-in first-out) memory 52C; a memory controller 53C for writing and reading data to and from the frame memory 23C; another FIFO memory 54C; and a multiplexer (MUX) 55C for multiplexing the video signal of the video input #3 onto the multiplexed video signal. In other words, the components ranging from the address section 51C to the FIFO memory 54C correspond to those of the frame synchronizer 22C in FIG. 1.

The multiplexers 55A through 55C correspond to the multiplexer 25 in FIG. 1.

When the processing sections for the different streams of the multiplexing block 11 are made structurally identical as described above, it is possible to design the multiplexing block 11 easily and reduce the cost of its development.

The memory controller 53A is furnished on its input and output sides with the FIFO memories 52A and 54A respectively; the memory controller 53B is provided on its input and output sides with the FIFO memories 52B and 54B respectively; and the memory controller 53C is equipped on its input and output sides with the FIFO memories 52C and 54C respectively. This arrangement permits reliable data transfers between different clock signals. The arrangement also helps buffer data rate deviations during memory access operations.

More specifically, in the multiplexing block 11 of FIG. 4, the video input #1 is input in the form of a DVI signal (DVI In) serving as a video signal that complies with the DVI (Digital Visual Interface) stipulated as a video data interface standard. The video input #2 is input in the form of an SD-SDI signal (SDI In) serving as a video signal that complies with the SD-SDI (Standard Definition Serial Digital Interface) established as an SD (Standard-Definition) image quality signal standard. The video input #3 is input in the form of an HD-SDI signal (HD-SDI In), a video signal that complies with the HD-SDI (High Definition Serial Digital Interface) set forth as a high-definition image quality signal standard.

The reception circuit 21A has a DVI receiver (DVI Rx) 61A that converts the DVI signal into a desired video signal. In operation, the reception circuit 21A creates a synchronizing signal and a data signal from the DVI signal, and sends the synchronizing signal to the address section 51A and the data signal to the FIFO memory 52A in the multiplexing unit 50A.

The reception circuit 21B has an SDI signal equalizer (SDI EQ) 61B and an SDI signal deserializer (SDI DeSer) 62B for converting the SD-SDI signal into a desired video signal. In operation, the reception circuit 21B creates a synchronizing signal and a data signal from the SD-SDI signal, and sends the synchronizing signal to the address section 51B and the data signal to the FIFO memory 52B in the multiplexing unit 50B.

The reception circuit 21C has an SDI signal equalizer (SDI EQ) 61C and an SDI signal deserializer (SDI DeSer) 62C for converting the HD-SDI signal into a desired video signal. In operation, the reception circuit 21C creates a synchronizing signal and a data signal from the HD-SDI signal, and sends the synchronizing signal to the address section 51C and the data signal to the FIFO memory 52C in the multiplexing unit 50C.

The frame image 81 of the DVI signal is represented by a horizontal stripe pattern as shown in a balloon 71. The frame image 82 of the SD-SDI signal is given as a left-to-right downward-sloping stripe pattern as shown in a balloon 72. The frame image 83 of the HD-SDI signal is provided as a left-to-right upward-sloping stripe pattern as shown in a balloon 73.

As discussed above, the timing generator (TG) 24 creates a multiplexed video frame 84 as frame data with no frame image content offering a screen size (resolution) large enough to have the frame images of all input video signals pasted therein in non-overlapping relation to one another, provided the bandwidth of the multiplexed video signal does not exceed the bandwidth of the input video port of the processor 12 as shown in a balloon 74. The multiplexed video frame 84 thus created is output to the multiplexer 55A.

Upon acquiring the multiplexed video frame 84, the multiplexer 55A causes the memory controller 53A to read the frame image 81 from the frame memory 23A in keeping with the synchronizing signal (Mux Sync) of the multiplexed video signal, and pastes (i.e., multiplexes) the read frame image 81 to predetermined coordinates in the multiplexed video frame 84 as indicated in a balloon 75. The multiplexer 55A proceeds to send the multiplexed video frame 84 pasted with the frame image 81 to the multiplexer 55B.

Upon acquiring the multiplexed video frame 84, the multiplexer 55B causes the memory controller 53B to read the frame image 82 from the frame memory 23B in keeping with the synchronizing signal (Mux Sync) of the multiplexed video signal, and pastes (multiplexes) the read frame image 82 to predetermined coordinates on the multiplexed video frame 84 in non-overlapping relation to the frame image 82 as indicated in a balloon 76. The multiplexer 55B proceeds to send the multiplexed video frame 84 pasted with the frame image 82 to the multiplexer 55C.

Upon acquiring the multiplexed video frame 84, the multiplexer 55C causes the memory controller 53C to read the frame image 83 from the frame memory 23C in keeping with the synchronizing signal (Mux Sync) of the multiplexed video signal, and pastes (multiplexes) the read frame image 83 to predetermined coordinates on the multiplexed video frame 84 in non-overlapping relation to the frame images 82 and 83 as indicated in a balloon 77. The multiplexer 55C proceeds to output the multiplexed video frame 84 pasted with the frame image 83.

The multiplexers 55A through 55C are preset with information about the multiplexed positions of the input video frames, i.e., information about which video frame should be pasted to what coordinates on the multiplexed video frame (e.g., starting coordinates, horizontal size, vertical size, starting line number, intra-line starting pixel number, continuous pixel length, and ending line number). The multiplexers 55A through 55C reference these settings when inserting the input video data into slots of the multiplexed video signal.

However, there is no guarantee that the frame frequency (frame rate) of an input video signal coincides with the frame frequency of the multiplexed video signal. This unpredictability is bypassed as follows: if the frame frequency of the multiplexed video signal is higher than the frame frequency of the input video signal, then the memory controllers 53A through 53C read the same input video frame a plurality of times; if the frame frequency of the multiplexed video signal turns out to be lower than the frame frequency of the input video signal, then the memory controllers 53A through 53C read the input video frame in a thinned-out manner to buffer the frame rate difference between the input video signal and the multiplexed video signal.

The multiplexed video frame 84 is output by the multiplexer 55C in such a manner that the frame images 81 through 83 are pasted to their respective coordinates in non-overlapping relation to one another on the frame 84 as indicated in a balloon 78. In this state, the multiplexed video frame 84 is supplied to the processor 12.

The processor 12 possesses prior information about the coordinates to which the frame images are pasted by the multiplexers 55A through 55C, frame frequencies, and frame phases indicative of relative deviations of frame starting timings, among others. Based on such information, the processor 12 readily extracts the embedded frame images of the video signals from the multiplexed video frame 84.

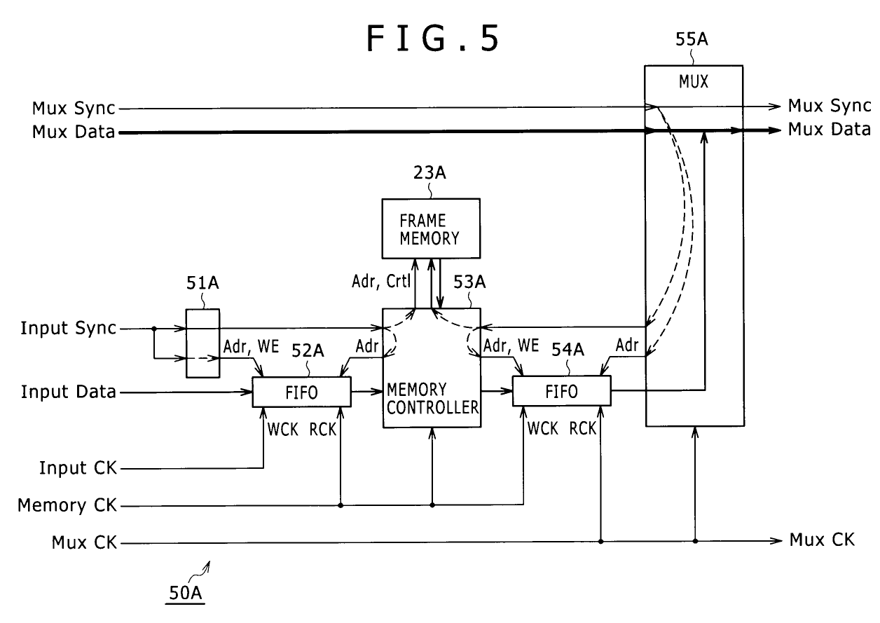

FIG. 5 schematically illustrates a more detailed structure of the multiplexing unit 50A. As shown in FIG. 5, the address section 51A creates address information based on the synchronizing signal of the input video signal (Input Sync) and sends the created information to the FIFO memory 52A and memory controller 53A. The FIFO memory 52A holds the input video signal (Input Data) at a designated address in accordance with a write timing clock signal WCK (Input CK). Upon acquiring the address from the address section 51A, the memory controller 53A reads the information from the FIFO memory 52A in accordance with a read timing clock signal RCK (Memory CK) and causes the information to be held at the address designated by the address section 51A of the frame memory 23A.

The multiplexer 55A crates address information based on the synchronizing signal of the multiplexed video signal (Mux Sync) and supplies the created address information to the memory controller 53A. The supplied information allows the memory controller 53A to read the video signal from the designated address in the frame memory 23A. The memory controller 53A then causes the video signal read from the frame memory 23A to be held at the address designated by the synchronizing signal of the multiplexed video signal (Mux Sync) in the FIFO memory 54A in accordance with the write timing clock signal WCK (Memory CK). The multiplexer 55A reads the information from the FIFO memory 54A in keeping with the read timing clock signal RCK (Mux CK) and superposes the retrieved information onto the multiplexed video signal (Mux Data).

The multiplexing units 50B and 50C work in the same manner as the multiplexing unit 50A discussed above in reference to FIG. 5 and thus will not be described further.

When a plurality of video signals are multiplexed onto the multiplexed video frame representing a single video signal as described above, the processor 12 can acquire a plurality of video input streams through a single port.

In the foregoing description, it was shown that the processor 12 has one video port (i.e., input terminal for one stream), that the multiplexing block 11 multiplexes the video signals of three streams into a multiplexed video signal of one stream and that the multiplexed video signal thus created is input to the processor 12 through the input terminal for one stream. Alternatively, the processor 12 may be furnished with video ports for a plurality of streams (i.e., input terminals for multiple streams). In this setup, a plurality of multiplexing blocks 11 are provided, each block 11 multiplexing a plurality of different video signals into a multiplexed video signal. The plurality of input video signals are thus arranged (multiplexed) into a number of streams not exceeding the number of the streams of input terminals (i.e., number of video ports) applicable to the processor 12. In this manner, the video signals of more streams than the number of the video ports possessed by the processor 12 may be input to the processor 12 through these video ports.

In the above setup, the multiplexing block 11 may admit video signals of as many streams as desired, provided they do not exceed the number of the video ports incorporated in the processor 12. The number of video signals to be multiplexed by each multiplexing block 11 into a single multiplexed video signal may be arbitrary, and each multiplexing block 11 may handle a different number of input video signals. As another alternative, every video port may be provided with the multiplexing block 11. As a further alternative, only part of the video ports may be provided with the multiplexing block 11. In the last case, the other video ports admit input video signals that are not multiplexed.

As an even further alternative, a plurality of multiplexing blocks 11 may be regarded as a single multiplexing block 11. That is, the multiplexing block 11 may multiplex part of a plurality of input video signals into a number of output video signals smaller than the number of the input video signals (i.e., smaller than the number of the video ports possessed by the processor 12). In this case, all video signals may be output in multiplexed video signals that are different from one another. Alternatively, part of the video signals may be output in multiplexed video signals and the rest may be output as video signals that are not multiplexed.

In other words, the processor 12 may acquire a number of video signals larger than the number of the video ports possessed by the processor 12.

In the above setups where a plurality of multiplexing blocks 11 are provided or where the multiplexing block 11 outputs a plurality of video signals, the workings of each multiplexing block 11 are basically the same as those discussed above in reference to FIGS. 4 and 5 and thus will not be described further.

In the setups above, the bandwidth of the multiplexed video signal needs to be narrower than the bandwidth of the video input port of the processor 12. It is also necessary that all input video frames be pasted onto the multiplexed video frame in non-overlapping relation to one another. That is, the screen size of the multiplexed video frame should preferably be as large as possible, provided the bandwidth of the multiplexed video signal does not exceed the bandwidth of the input video port of the processor 12. There are no constraints illustratively on frame sizes, frame frequencies (frame rates), and frame phases representative of the relative deviations of frame starting timings.

The frame synchronizer 22 adjusts the frame frequency through duplication and thinning-out of frames. It follows that the nearer the frame frequency of the multiplexed video signal and the frame frequency of the input video signals to be multiplexed, the higher the fidelity of the image. If it is desired to prevent dropping frames, which would result in missing information, then the frame frequency of the multiplexed video signal should preferably be made higher than the frame frequency of input video signals. Illustratively, if the frame frequency of input video signals coincides with that of the multiplexed video signal, that means the frame synchronizer 22 simply operates as an input buffer (FIFO).

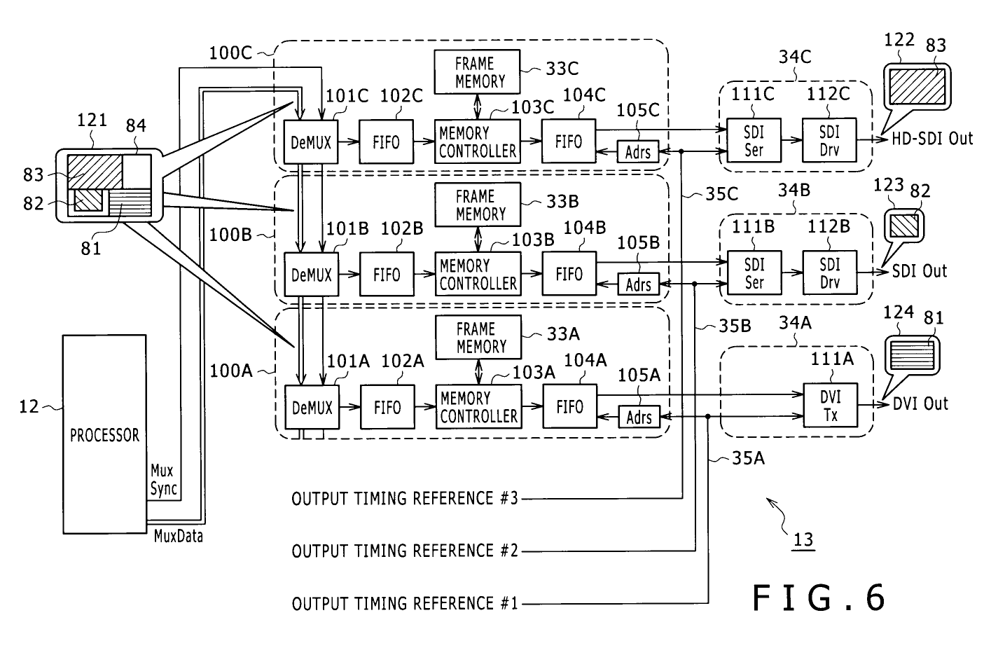

FIG. 6 schematically shows a detailed structure of the extraction block 13.

The extraction block 13 is basically the same in structure as the multiplexing block 11. The demultiplexer 31 may be formed by demultiplexers 101A through 101C each capable of extracting a single video signal from the multiplexed video frame.

A demultiplexing unit 100A is configured to process the video output #1. In addition to the demultiplexer (DeMUX) 101A and frame memory 33A, the demultiplexing unit 100A includes an FIFO memory 102A, a memory controller 103A, an FIFO memory 104A, and an address section 105A corresponding to the frame synchronizer 32A.

A demultiplexing unit 100B is configured to process the video output #2. In addition to the demultiplexer (DeMUX) 101B and frame memory 33B, the demultiplexing unit 100B includes an FIFO memory 102B, a memory controller 103B, an FIFO memory 104B, and an address section 105B corresponding to the frame synchronizer 32B.

A demultiplexing unit 100C is configured to process the video output #3. In addition to the demultiplexer (DeMUX) 101C and frame memory 33C, the demultiplexing unit 100C includes an FIFO memory 102C, a memory controller 103C, an FIFO memory 104C, and an address section 105C corresponding to the frame synchronizer 32C.

When the processing sections of the different streams in the extraction block 13 are made structurally identical to one another, it is easy to design the extraction block 13 and thus reduce the cost of its development.

The memory controller 103A is furnished on its input and output sides with the FIFO memories 102A and 104A respectively; the memory controller 103B is provided on its input and output sides with the FIFO memories 102B and 104B respectively; and the memory controller 103C is equipped on its input and output sides with the FIFO memories 102C and 104C respectively. This arrangement permits reliable data transfers between different clock signals. The arrangement also helps buffer data rate deviations during memory access operations.

More specifically, the DVI signal extracted by the extraction block 13 in FIG. 6 from the multiplexed video signal output by the processor 12 is output as the video output #1 (DVI Out); the SD-SDI signal extracted in like manner from the multiplexed video signal is output as the video output #2 (SDI Out); and the HD-SDI signal extracted likewise from the multiplexed video signal is output as the video output #3 (HD-SDI Out).

The multiplexed video frame (Mux Data) output by the processor 12 together with the synchronizing signal (Mux Sync) is fed to the demultiplexer 101C of the demultiplexing unit 100C. As shown in a balloon 121, the multiplexed video frame 84 has the frame images 81 through 83 pasted thereon in non-overlapping relation to one another.

The demultiplexer 101C extracts from the multiplexed video frame 84 the frame image 83 to be converted to an HD-SDI signal. The extracted frame image 83 is sent to the memory controller 103C through the FIFO memory 102C. The demultiplexer 101C possesses prior information about the coordinates at which at least the frame image 83 is embedded in the multiplexed video frame 84, frame frequencies, and frame phases indicative of relative deviations of frame starting timings, among others. Based on such information, the demultiplexer 101C can correctly extract the frame image 83 from the multiplexed video frame 84.

The memory controller 103C causes the frame memory 33C to hold temporarily the frame image 83 (frame data) having been supplied. In accordance with the output timing reference signal #3, the memory controller 103C reads the frame image 83 from the frame memory 33C and forwards the read frame image 83 to the transmission circuit 34C through the FIFO memory 104C.

The transmission circuit 34C includes an SDI signal serializer (SDI Ser) 111C and an SDI signal driver (SDI Drv) 112C. Using these components, the transmission circuit 34C converts the video signal (i.e., frame image 83) from the unit 100C into an HD-SDI signal that is output (HD-SDI Out). That is, the frame image 83 is output as the video output #3 as indicated in a balloon 122.

The demultiplexer 101C further supplies the demultiplexer 101B of the demultiplexing unit 100B with the multiplexed video frame (Mux Data) along with the synchronizing signal (Mux Sync) output by the processor 12.

The demultiplexer 101B extracts from the multiplexed video frame 84 the frame image 82 to be converted to an SD-SDI signal. The extracted frame image 82 is sent to the memory controller 103B through the FIFO memory 102B. The demultiplexer 101B possesses prior information about the coordinates at which at least the frame image 82 is embedded in the multiplexed video frame 84, frame frequencies, and frame phases indicative of relative deviations of frame starting timings, among others. Based on such information, the demultiplexer 101B can correctly extract the frame image 82 from the multiplexed video frame 84.

The memory controller 103B causes the frame memory 33B to hold temporarily the frame image 82 (frame data) having been supplied. In accordance with the output timing reference signal #2, the memory controller 103B reads the frame image 82 from the frame memory 33B and forwards the read frame image 82 to the transmission circuit 34B through the FIFO memory 104B.

The transmission circuit 34B includes an SDI signal serializer (SDI Ser) 111B and an SDI signal driver (SDI Drv) 112B. Using these components, the transmission circuit 34B converts the video signal (i.e., frame image 82) from the demultiplexing unit 100B into an SD-SDI signal that is output (SD-SDI Out). That is, the frame image 82 is output as the video output #2 as indicated in a balloon 123.

The demultiplexer 101B further supplies the demultiplexer 101A of the demultiplexing unit 100A with the multiplexed video frame (Mux Data) along with the synchronizing signal (Mux Sync) output by the demultiplexer 101C.

The demultiplexer 101A extracts from the multiplexed video frame 84 the frame image 81 to be converted to a DVI signal. The extracted frame image 81 is sent to the memory controller 103A through the FIFO memory 102A. The demultiplexer 101A possesses prior information about the coordinates at which at least the frame image 81 is embedded in the multiplexed video frame 84, frame frequencies, and frame phases indicative of relative deviations of frame starting timings, among others. Based on such information, the demultiplexer 101A can correctly extract the frame image 81 from the multiplexed video frame 84.

The memory controller 103A causes the frame memory 33A to hold temporarily the frame image 81 (frame data) having been supplied. In accordance with the output timing reference signal #1, the memory controller 103A reads the frame image 81 from the frame memory 33A and forwards the read frame image 81 to the transmission circuit 34A through the FIFO memory 104A.

The transmission circuit 34A includes a DVI transmitter (DVI Tx) 111A. Using this component, the transmission circuit 34A converts the video signal (i.e., frame image 81) from the demultiplexing unit 100A into a DVI signal that is output (DVI Out). That is, the frame image 81 is output as the video output #1 as indicated in a balloon 124.

However, there is no guarantee that the frame frequency (frame rate) of the multiplexed video signal coincides with the frame frequency of the output video signals. This unpredictability is bypassed as follows: if the frame frequency of the output timing reference signal is higher than the frame frequency of the multiplexed video signal, then the same output video frame is read a plurality of times; if the frame frequency of the output timing reference signal turns out to be lower than the frame frequency of the multiplexed video signal, then the output video frame is read from the frame memory 33 in a thinned-out manner in order to buffer the frame rate difference between the output timing reference signal and the multiplexed video signal.

In reference to FIG. 6, as shown in the balloon 121, the multiplexed video frame 84 acquired by the demultiplexers 101A through 101C was described as having the frame images 81 through 83 pasted thereon in non-overlapping relation to one another, just like the multiplexed video frame 84 having been output earlier by the processor 12 (i.e., the frame images 81 through 83 remain in their respective positions). However, this is not limitative of the present invention. Alternatively, each demultiplexer 101 may extract the relevant frame image from the multiplexed video frame before forwarding the latter minus the extracted frame image to the downstream stage. In the example of FIG. 6, the multiplexed video frame 84 fed to the demultiplexer 101B from the demultiplexer 101C may have only the fame images 81 and 82 pasted thereon and devoid of the frame image 83; and the multiplexed video frame 84 sent to the demultiplexer 101A from the demultiplexer 101B may have only the frame image 81 pasted thereon and devoid of the frame images 82 and 83.

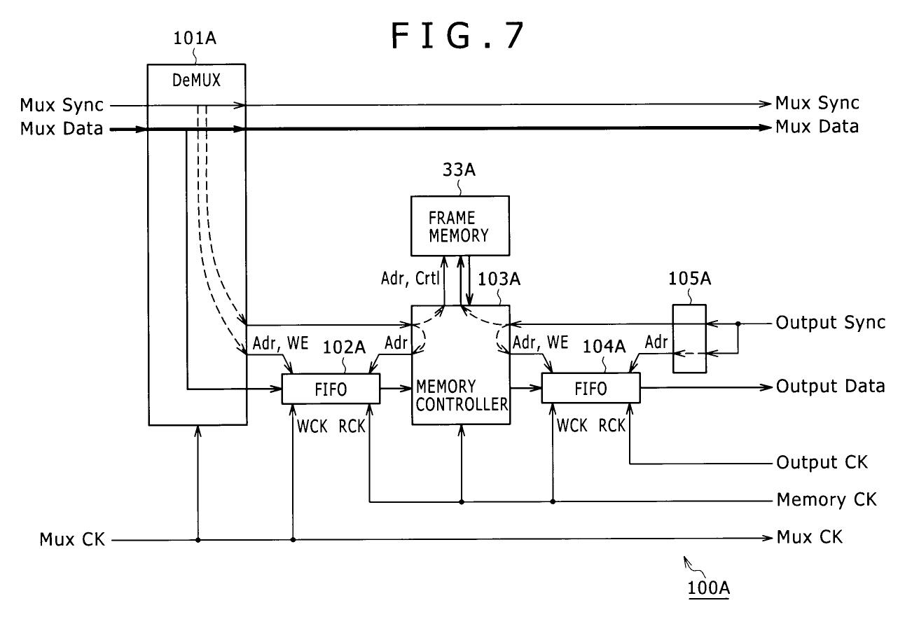

FIG. 7 schematically shows a more detailed structure of the demultiplexing unit 100A. As indicated in FIG. 7, the demultiplexer 101A creates address information based on the synchronizing signal of the multiplexed video signal (Mux Sync) and sends the created information to the FIFO memory 102A and memory controller 103A. The FIFO memory 102A holds the video signal extracted from the multiplexed video signal at a designated address in accordance with the write timing clock signal WCK (Input CK). Using the designated address, the memory controller 103A reads the information from the FIFO memory 102A in accordance with the read timing clock signal RCK (Memory CK) and causes the information to be held in the frame memory 33A.

The address section 105A creates address information based on the output timing reference signal #1 (Output Sync) and sends the created information to the FIFO memory 104A and memory controller 103A via the signal line 35A. The memory controller 103A reads the information from the designated address in the frame memory 33A and causes the FIFO memory 104A to hold the read information at the address designated in accordance with the write timing signal WCK (Memory CK). The FIFO memory 104A outputs the address information (Output Data) in keeping with the read timing signal RCK (Mux CK).

The demultiplexing units 100B and 100C operate in the same manner as the demultiplexing unit 100A discussed above in reference to FIG. 7 and thus will not be described further.

When a plurality of video signals are multiplexed onto the multiplexed video frame representing a single video signal as described above, the processor 12 can output a plurality of video output streams through a single port.

In the foregoing description, it was shown that the processor 12 has one video port (i.e., output terminal for one stream), that the extraction block 13 acquires the multiplexed video signal of one stream having video signals of three streams multiplexed therein and that the individual video signals are extracted from the multiplexed video signal thus acquired. Alternatively, the processor 12 may be furnished with video ports for a plurality of streams (i.e., output terminals for multiple streams). In this setup, there may be provided as many extraction blocks 13 as the number of the streams of the multiplexed video signals output by the processor 12. This enables the image processing system 10 to let each of the extraction blocks 13 extract individual video signals from the multiplexed video signals that are different from one another. That is, with the image processing system 10 in operation, the processor 12 can output a number of video signals larger than the number of the video ports the processor 12 possesses through these video ports.

As many extraction blocks 13 as desired may thus be installed, provided their number is larger than the number of the multiplexed video signals output by the processor 12. The number of the video signals to be extracted by each of the configured extraction blocks 13 is determined by the number of the video signals multiplexed into the corresponding multiplexed video signal. The extracted video signal count may therefore differ from one extraction block 13 to another.

Of the plurality of video ports possessed by the processor 12, part of them may be arranged to output multiplexed video signals while the rest may output video signals that are not multiplexed. In this case, the number of the configured extraction blocks 13 need only be larger than the number of the multiplexed video signals to be output by the processor 12.

Alternatively, the plurality of extraction blocks 13 may be regarded as a single extraction block 13. That is, the extraction block 13 may be arranged to extract video signals from each of a plurality of multiplexed video signals.

Where the extraction block or blocks 13 are provided as described, the processor 12 can output a number of video signals larger than the number of the video ports possessed by the processor 12.

In the above setups where a plurality of extraction blocks 13 are provided or where the extraction block 13 outputs a plurality of video signals, the workings of each extraction block 13 are basically the same as those discussed above in reference to FIGS. 6 and 7 and thus will not be described further.

In the setups above, the bandwidth of the multiplexed video signal needs to be narrower than the bandwidth of the video output port of the processor 12. It is also necessary that all input video frames be pasted onto the multiplexed video frame in non-overlapping relation to one another. That is, the screen size of the multiplexed video frame should preferably be as large as possible, provided the bandwidth of the multiplexed video signal does not exceed the bandwidth of the input video port of the processor 12. There are no constraints illustratively on frame sizes, frame frequencies (frame rates), and frame phases representative of the relative deviations of frame starting timings. Referring to FIG. 1, the format of the multiplexed video signal on the output side of the processor 12 is independent of the format of the multiplexed video signal on the input side of the processor 12. These formats may or may not coincide with one another.

In order to let the video signal created by the processor 12 be output with high fidelity, it is preferred that the frame frequency of the multiplexed video signal coincide with that of the video signal to be output. Where the frame frequency of the multiplexed video signal coincides with that of the output video signal, the frame synchronizer 32 simply operates as an input buffer (FIFO).

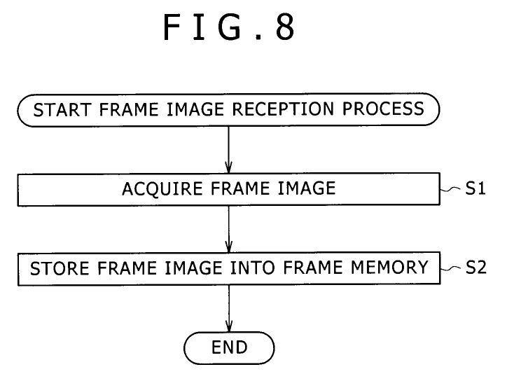

Described below in reference to the flowchart of FIG. 8 is the frame image reception process performed by the above-described multiplexing block 11. This process is carried out on each input stream every time a frame image (i.e., input video signal) is supplied from the outside.

In step S1, the reception circuit 21 acquires the frame image. In step S2, the frame synchronizer 22 places the frame image into the frame memory 23 for storage. This step completes the frame image reception process.

It is to be noted the frame image reception process is carried out on each of the input streams involved, independent of one another.

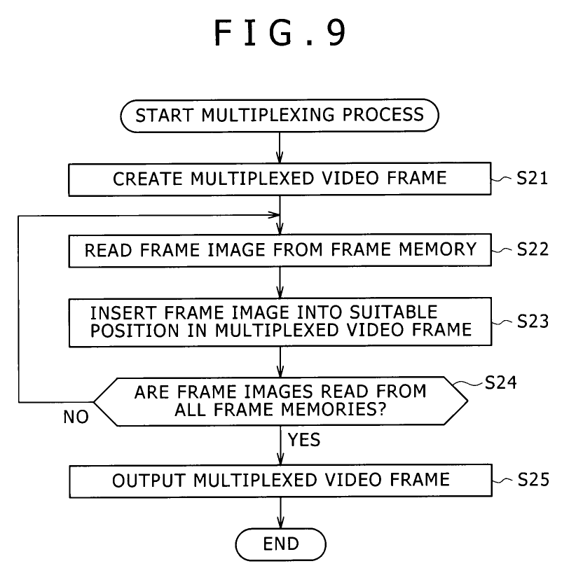

Explained below in reference to the flowchart of FIG. 9 is the multiplexing process performed by the multiplexing block 11 for multiplexing frame images onto a multiplexed video frame.

In step S21, the timing generator 24 creates the multiplexed video frame. In step S22, the frame synchronizer 22 corresponding to the stream being processed (i.e., video signal) reads the frame image currently held in the frame memory 23 applicable to the stream in question.

In this step, the frame image is read at the frame rate of the multiplexed video signal. As a result, the frame may be read either repeatedly or in thinned-out fashion.

The multiplexer 25 pastes (i.e., multiplexes) the read frame image to suitable coordinates on the multiplexed video frame. In step S24, the frame synchronizer 22 checks to determine whether the frame images have been read from all frame memories (frame memories 23 for all streams). If any frame image yet to be processed is found to exist on any stream, then control is returned to step S22. Then frame image is then read again from the frame memory corresponding to the stream in question.

If in step S24 the frame images are found to have been read from the frame memories 23 of all streams, i.e., if the frame images of all streams are found to be pasted onto the multiplexed video frame, then control is passed on to step S25. In step S25, the multiplexer 25 outputs the multiplexed video frame to the processor 12. The processor 12 acquires the multiplexed video frame through an input port for one stream. After execution of step S25, the multiplexing block 11 terminates the multiplexing process.

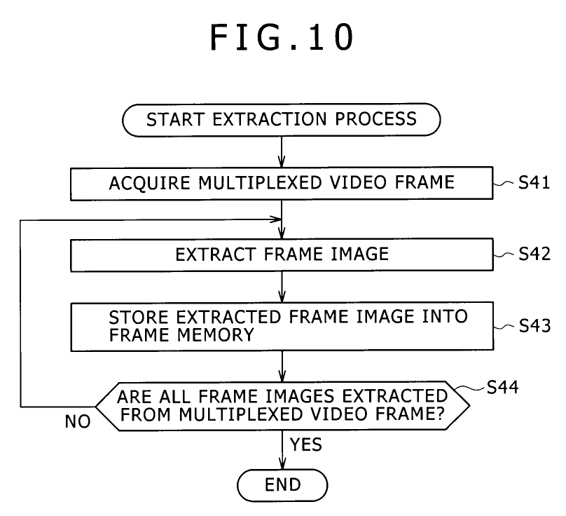

Described below in reference to the flowchart of FIG. 10 is the extraction process performed by the extraction block 13 for extracting individual frame images from the multiplexed video frame.

With the extraction process started, the demultiplexer 31 of the extraction block 13 goes to step S41 and acquires the multiplexed video frame output by the processor 12. With the multiplexed video frame acquired, step S42 is reached. In step S42, the extraction block 13 extracts from the multiplexed video frame the fame image corresponding to the output stream being processed. In step S43, the frame synchronizer 32 stores the extracted frame image into the frame memory 33.

In step S44, the demultiplexer 31 checks to determine whether all frame images have been extracted from the multiplexed video frame. If in step S44 any other output stream is found to have any frame image yet to be processed, then control is returned to step S42 and the subsequent steps are repeated on the new output stream.

If in step S44 all frame images are found to be extracted, the extraction process is terminated.

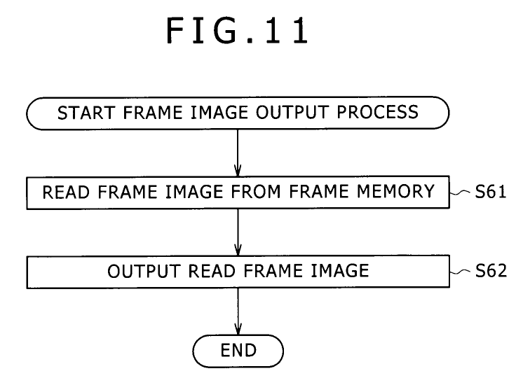

Explained below in reference to the flowchart of FIG. 11 is the frame image output process performed by the above-described extraction block 13. The frame image output process is carried out on each of the output streams involved every time a frame image is extracted from the multiplexed video frame.

In step S61, the frame synchronizer 32 reads the frame image held in the frame memory 33. In step S62, the transmission circuit 34 sends the read frame image to the outside. This step completes the frame image output process.

It is to be noted that the frame image output process is carried out on each of the output streams involved, independent of one another.

As described above, there is no correlation in conditions between the input video signals to be multiplexed by the multiplexing block 11, nor is there interdependency between input streams (i.e., channels) in terms of processing. There are no specific conditions applicable to the multiplexing process except that the input frames need to be pasted on the multiplexed video frame in non-overlapping relation to one another. There is no preferential sequence in which the input frames are to be embedded into the multiplexed video frame as long as they are positioned in non-overlapping relation to one another.

It follows that as described above in reference to FIG. 4, the multiplexing block 11 can be constituted by the same circuits with different input frame coordinates for multiplexing and with different resolution settings on each input stream.

The same applies to the extraction block 13, to be constituted by the same circuits with different input frame coordinates for multiplexing and with different resolution settings as discussed above in reference to FIG. 6.

In other words, a desired input circuit is configured by simply connecting in series as many multiplexing circuit modules as the number of input video signals, each multiplexing circuit module being simply structured to multiplex a single video signal onto the multiplexed video signal. A desired output circuit is configured by simply connecting in series as many separation circuit modules as the number of output video signals, each separation circuit module being simply structured to separate a single video signal from the multiplexed video signal. Because there is no need to design individually as many circuits as the number of input and output video streams, design work is simplified and the cost of circuit development is lowered accordingly.

In the foregoing description, the frame frequency of the multiplexed video signal was shown to be determined independently of input video signals. Alternatively, the frame frequency of the multiplexed video signal may be arranged to coincide with the frame frequency of an input video signal. As another alternative, the frame frequency of the multiplexed video signal may be correlated with the frame frequency of an input video signal.

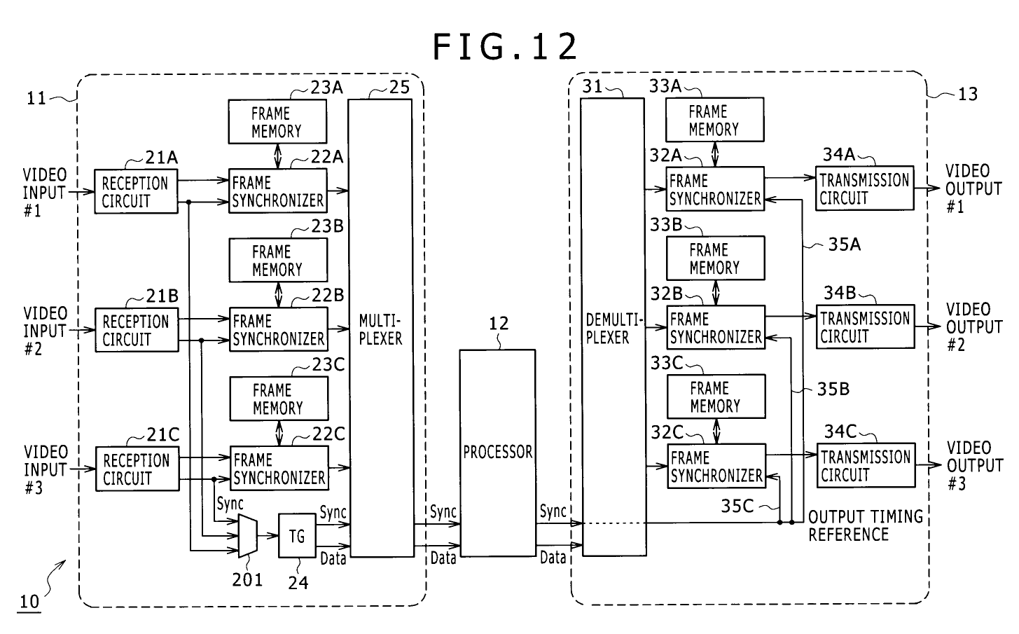

FIG. 12 is a block diagram showing a typical configuration of another typical image processing system embodying the present invention.

In the example of FIG. 12, the multiplexing block 11 is furnished with a switch 201 for selecting one of the synchronizing signals specific to the video signals on different input streams. Using the synchronizing signal selected by the switch 201, the timing generator 24 causes the frame frequency of the multiplexed video signal to coincide or correlate with the frame frequency of the video signal on the selected input stream.

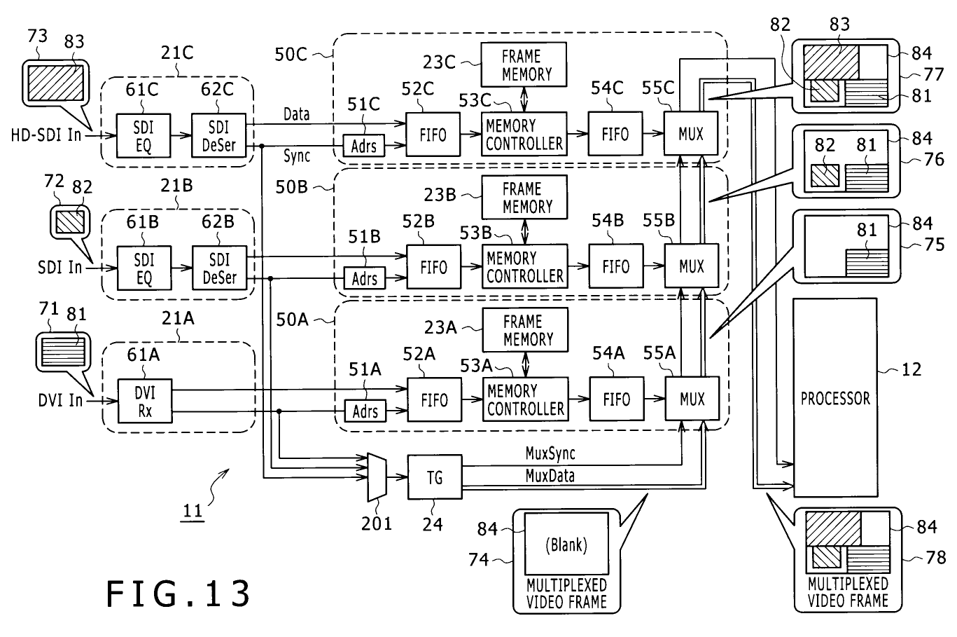

Illustratively, the switch 201 selects the synchronizing signal of the video signal having the highest frame frequency from among the video signals that have been input on different input streams. The selection allows the timing generator 24 to let the frame frequency of the multiplexed video signal coincide with the highest frame frequency of the video signals to be multiplexed, so that no data will be lost in multiplexing frame images. If the input video signal on each of the streams involved is determined in advance and if the frame frequency of each stream is known beforehand, then the switch 201 may be omitted and the synchronizing signal of the currently processed stream may be fed directly to the timing generator 24.

Where the synchronizing signal of each stream need only be supplied (through the switch 201) to the timing generator 24, it is easy to provide the multiplexing unit 50 for each input stream as explained above in reference to FIG. 4. How the multiplexing units 50 may be typically furnished is illustrated in FIG. 13.

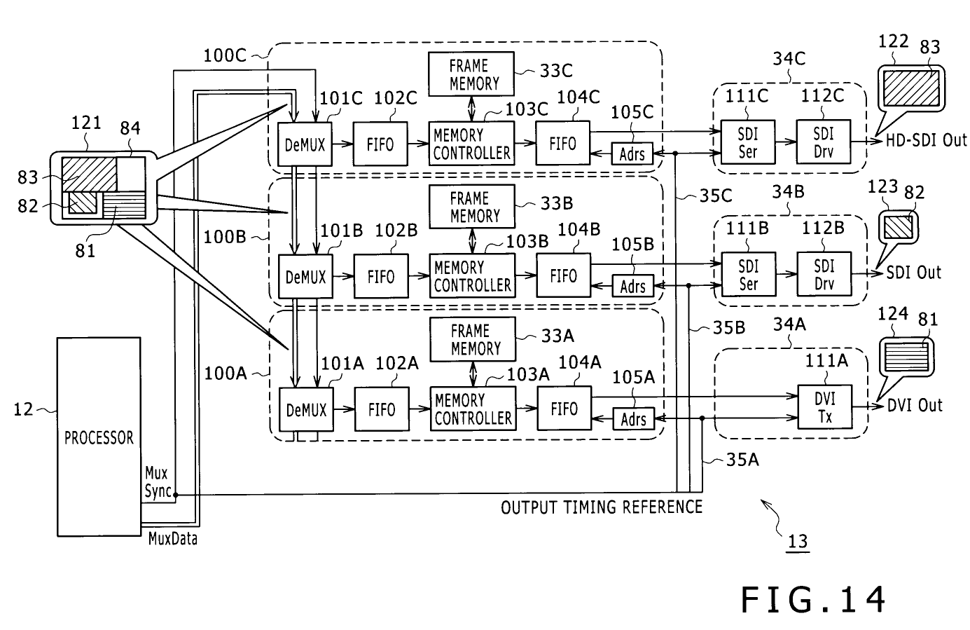

In the foregoing description, the output timing reference signal was shown to be any desired signal. Alternatively, as shown in FIG. 12, the output timing signal of the processor 12 may be appropriated as the output timing reference signal. In this case, the synchronizing signal output by the processor 12 need only be fed to each of the frame synchronizers 32 on different streams. The setup makes it easy to install the same demultiplexing unit 100 for each of the output streams involved as explained above in reference to FIG. 6. How the demultiplexing units 100 may be typically furnished is illustrated in FIG. 14.

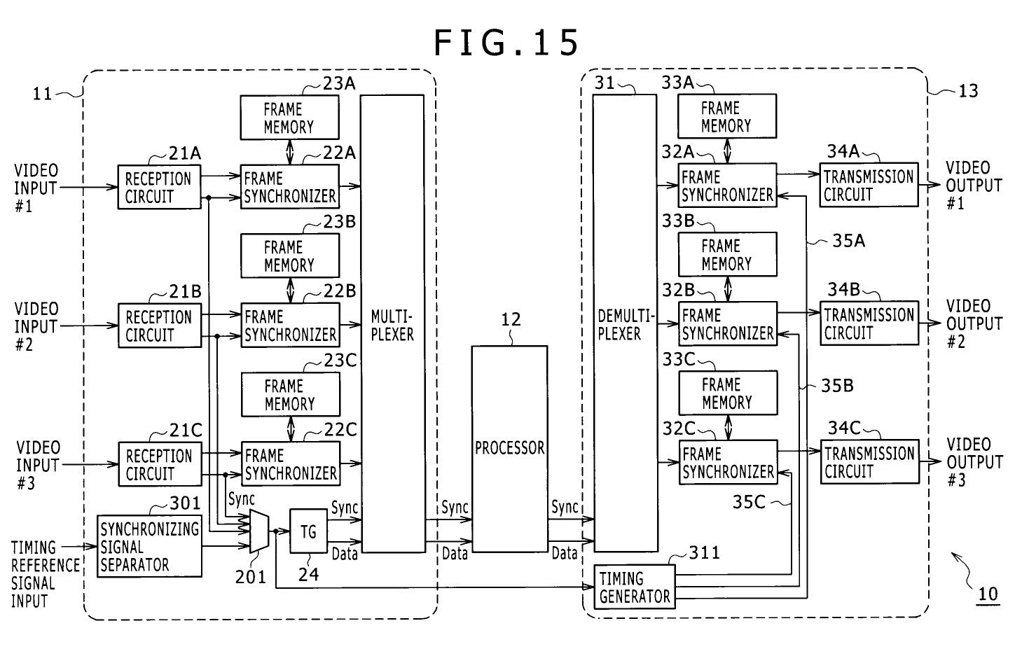

FIG. 15 is a block diagram showing a typical configuration of a further image processing system embodying the present invention.

In the example of FIG. 15, the multiplexing block 11 is provided with a synchronizing signal separator 301 for separating a synchronizing signal from the timing reference signal which is supplied from outside the image processing system 10 and which comes independent of the video signals inside the image processing system 10. The synchronizing signal thus extracted by the synchronizing signal separator 301 is fed to the switch 201 as one of its signal options. By utilizing the synchronizing signal supplied from outside the image processing system 10 and selected by the switch 201, the timing generator 24 may cause the frame frequency of the multiplexed video signal to coincide or correlate with the frequency of the synchronizing signal. In this case, it is possible to control the frame frequency of the multiplexed video signal from outside the image processing system 10.

Alternatively, the switch 201 may be omitted to let the synchronizing signal output by the synchronizing signal separator 301 be fed directly to the timing generator 24.

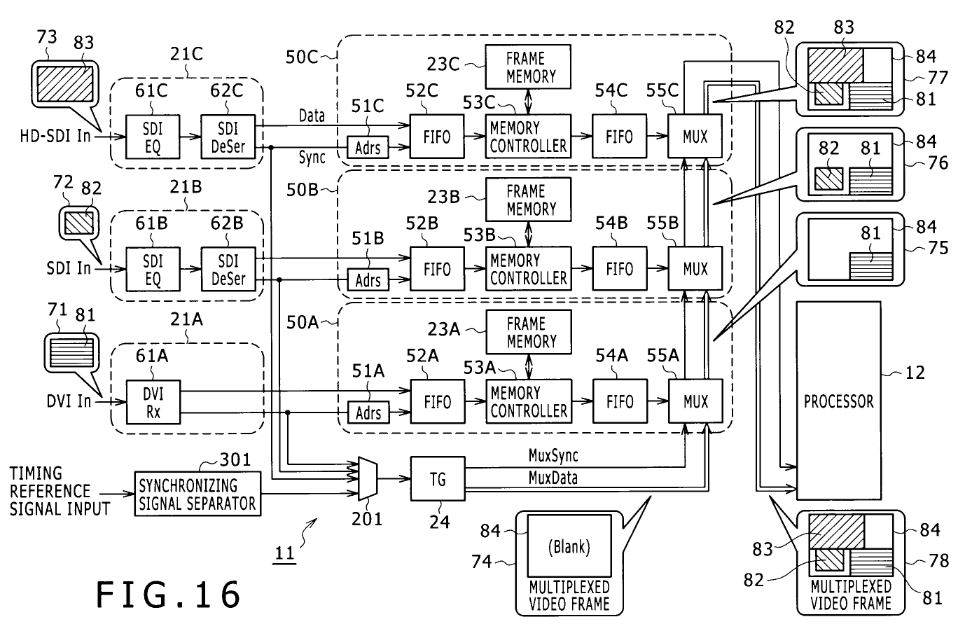

In any case, too, the synchronizing signal need only be separated by the synchronizing signal separator 301 from the timing reference signal supplied from outside the image processing system 10 and forwarded to the timing generator 24 (through or without the switch 201). This arrangement makes it easy to provide the multiplexing unit 50 for each input stream as explained above in reference to FIG. 4. How the multiplexing units 50 may be typically furnished is illustrated in FIG. 16.

In another example, as shown in FIG. 15, the output timing reference signal may be created using the timing signal extracted from the input video signal or through the use of a timing signal supplied from outside the system. In FIG. 15, the extraction block 13 includes a timing generator 311 that sets the output timings for the video signals on different output streams in keeping with the synchronizing signal selected by the switch 201 in the multiplexing block 11. Using the synchronizing signal selected by the switch 201 in the multiplexing block 11, the timing generator 311 generates the output timing signals for the video signals on the different output streams and supplies the generated timing signals to the frame synchronizers 32 on the streams involved.

As described, the extraction block 13 outputs the video signal on each of the different streams in a manner coinciding or correlating with the input timing signal that is input to the multiplexing block 11.

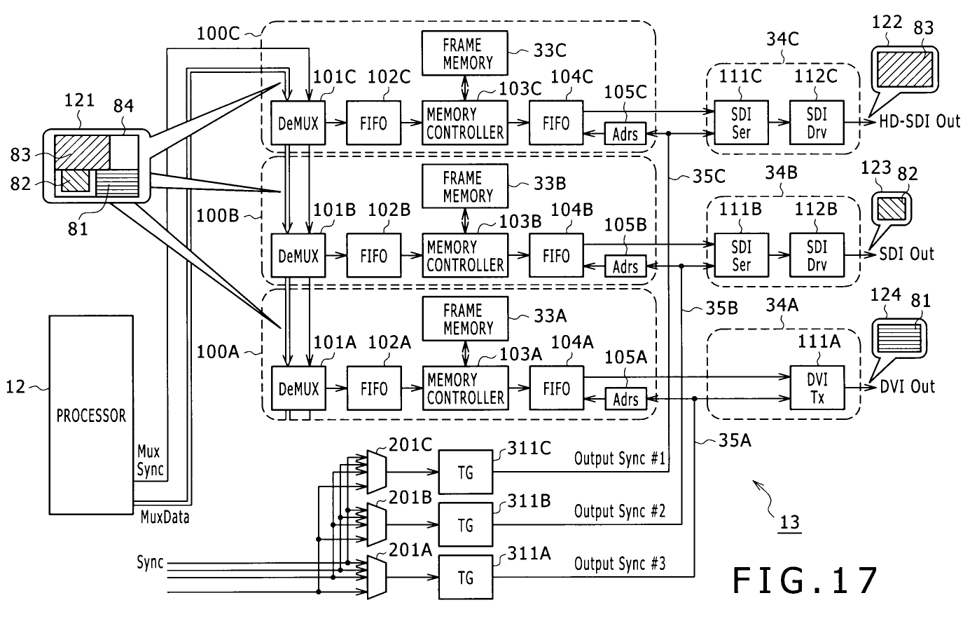

The timing generator 311 may be provided in the form of a plurality of units operating independently of one another on the output streams involved, such as timing generators (TG) 311A, 311B and 311C in FIG. 17. In this case, the switch 201 may also be furnished in the form of a plurality of units each capable of selecting the synchronizing signal for each of the different output streams, such as switches 201A, 201B and 201C. In the example of FIG. 17, the timing generators (TG) 311A, 311B and 311C can set output timings using synchronizing signals that are different from one another.

The output timing signals, not shown, may be generated internally by the image processing system 10.

As described, the multiplexing block 11 supplies the processor 12 with a single video format in which a plurality of video signals from a plurality of input streams are multiplexed. The extraction block 13 extracts individually a plurality of video signals from a single video format from the processor 12 and outputs the extracted video signals over different output streams to the downstream stage. These arrangements make it easy to reduce the number of streams for transmitting video signals to be input to or output from the processor 12. That is, the number of input/output pins on the processor 12 can be reduced with little difficulty, and the manufacturing cost of the processor 12 can be lowered correspondingly.

In the foregoing description, the multiplexing block 11 and extraction block 13 were shown to handle the input and output to and from the processor 12. However, this is not limitative of the present invention. The processor 12 merely constitutes one typical block for processing the multiplexed video signal and may be replaced by some other suitable entity, such as storage media for storing the multiplexed video signal or transmission media for transmitting the multiplexed video signal.

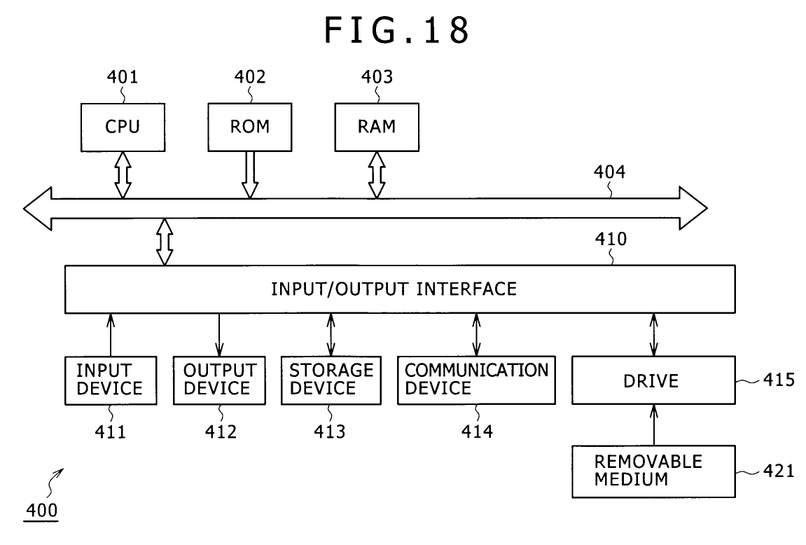

The series of the steps or processes described above may be executed either by hardware or by software. In either case, a personal computer (PC) such as one shown in FIG. 18 may be used to perform the processing.

In FIG. 18, a CPU 401 of a personal computer 400 carries out various processes in accordance with the programs stored in a ROM 402 or as per the programs loaded from a storage device 413 into a RAM 403. The RAM 403 may also hold data that may be needed by the CPU 401 in performing its processing.

The CPU 401, ROM 402, and RAM 403 are interconnected by a bus 404. An input/output interface 410 is also connected to the bus 404.

The input/output interface 410 is connected with an input device 411, an output device 412, a storage device 413, and a communication device 414. The input device 411 is typically made up of a keyboard and a mouse. The output device 412 is constituted illustratively by a display unit such as a CRT (cathode ray tube) or LCD (liquid crystal display) and by speakers. The storage device 413 is generally composed of a hard disk drive. The communication device 414, typically formed by a modem, conducts communications over networks such as the Internet.

A drive 415 may be connected as needed to the input/output interface 410. A piece of removable media 421 such as magnetic disks, optical disks, magneto-optical disks or semiconductor memories may be loaded as needed into the drive, and the computer programs retrieved from the loaded removable medium may be installed as needed into the storage device 413.

Where the above-described steps or processes are to be executed by software, the programs making up the software may be installed into the CP over the network or from suitable recording medium.

As shown illustratively in FIG. 18, the recording media which are offered to users apart from their computers and which accommodate the above-mentioned programs are constituted not only by such removable media 421 as magnetic disks (including flexible disks), optical disks (including CD-ROM (compact disc read-only memory) and DVD (digital versatile disc)), magneto-optical disks (including MD (Mini-disc)), or semiconductor memories; but also by such media as the ROM 402 or the hard disks contained in the storage device 413. The latter recording media are preinstalled in the computer when offered to the users and have the programs stored thereon beforehand.

In this specification, the steps describing the programs stored on the program recording media represent not only the processes that are to be carried out in the depicted sequence (i.e., on a time series basis) but also processes that may be performed parallelly or individually and not chronologically.

In this specification, the term “system” refers to an entire configuration made up of a plurality of component devices or apparatuses.

Any one of such component devices or apparatuses may be constituted by a plurality of functional segments. Alternatively, a plurality of such component devices or apparatuses may be arranged into a single device or apparatus. The component devices or apparatuses may obviously be structured in a manner different from the way they were shown structured above. Part of a given component device may be included in another component device or devices, provided the system as a whole is substantially consistent in structure and performance.

While some preferred embodiments of this invention have thus been described using specific terms, such description is for illustrative purposes only, and it is to be understood that changes and variations may be made without departing from the spirit or scope of the claims that follow.

What is claimed is:

1. An information processing apparatus causing a larger number of video signals than at least one video port possessed by a processor to be input to said processor through said video port, said information processing apparatus comprising:
multiplexed video frame creation means for creating multiplexed video frames in such a manner that each of said multiplexed video frames has said video signals multiplexed for input to said processor through said video port and includes a sufficiently large number of pixels so that frame images represented individually by said video signals may be pasted onto each multiplexed video frame in non-overlapping relation to one another; and
multiplexing means for multiplexing said video signals in such a manner that the frame images represented individually by said video signals are pasted in non-overlapping relation to one another onto each of said multiplexed video frames created by said multiplexed video frame creation means.

2. The information processing apparatus according to claim 1, wherein the formats of said video signals are independent of one another.

3. The information processing apparatus according to claim 1, further comprising:
holding means for holding the frame images of said video signals; and
reading means for reading said frame images from said holding means,
wherein said multiplexing means pastes onto each of said multiplexed video frames the frame images read by said reading means from said holding means.

4. The information processing apparatus according to claim 3, wherein said reading means reads the same frame images from said holding means a plurality of times if the frame frequency of said multiplexed video frames is higher than the frame frequency of the video signals of which the frame images are to be pasted onto said multiplexed video frames, and said reading means further reads the same frame images from said holding means in a thinned-out manner if the frame frequency of said multiplexed video frames is lower than the frame frequency of the video signals of which the frame images are to be pasted onto said multiplexed video frames.

5. The information processing apparatus according to claim 1, further comprising
selection means for selecting one of synchronizing signals specific to said video signals,
wherein said multiplexed video frame creation means creates said multiplexed video frames in such a manner that the frame frequency of said multiplexed video frames coincides with the frame frequency of the video signal of which the synchronizing signal is selected by said selection means.

6. The information processing apparatus according to claim 1, further comprising
synchronizing signal separation means for separating a synchronizing signal from a timing reference signal independent of said video signals for extraction of said synchronizing signal,
wherein said multiplexed video frame creation means creates said multiplexed video frames in such a manner that the frame frequency of said multiplexed video frames coincides with the frequency of said synchronizing signal extracted by said synchronizing signal separation means.

7. An information processing method for use with an information processing apparatus for causing a larger number of video signals than at least one video port possessed by a processor to be input to said processor through said video port, said information processing method comprising the steps of:
creating multiplexed video frames in such a manner that each of said multiplexed video frames has said video signals multiplexed for input to said processor through said video port and includes a sufficiently large number of pixels so that frame images represented individually by said video signals may be pasted onto each multiplexed video frame in non-overlapping relation to one another; and
multiplexing said video signals in such a manner that the frame images represented individually by said video signals are pasted in non-overlapping relation to one another onto each of said multiplexed video frames created in said multiplexed video frame creating step.

8. An information processing apparatus causing a larger number of video signals than at least one video port possessed by a processor to be output from said processor through said video port, said information processing apparatus comprising:
acquisition means for acquiring a multiplexed video signal which is output by said processor through said video port and which has said video signals multiplexed; and
extraction means for extracting individually frame images of said video signals from a frame image which is constituted by said multiplexed video signal acquired by said acquisition means and which has a sufficiently large number of pixels so that the frame images of said video signals are being pasted on said frame image in non-overlapping relation to one another.

9. The information processing apparatus according to claim 8, wherein the formats of said video signals are independent of one another.

10. The information processing apparatus according to claim 8, further comprising:
holding means for holding the frame images of said video signals extracted by said extraction means; and
reading means for reading said frame images from said holding means,
wherein said reading means reads said frame images from said holding means with a predetermined frame frequency and allows each of the read frame images to be output through a different stream.

11. The information processing apparatus according to claim 10, wherein said reading means reads the same frame images from said holding means a plurality of times if the frame frequency of the video signals to be output is higher than the frame frequency of said multiplexed video signal, and said reading means further reads the same frame images from said holding means in a thinned-out manner if the frame frequency of the video signals to be output is lower than the frame frequency of said multiplexed video signal.

12. The information processing apparatus according to claim 10, further comprising
timing generation means for generating a timing signal for designating the timing at which said reading means reads said frame images from said holding means and outputs the read frame images.

13. An information processing method for use with an information processing apparatus for causing a larger number of video signals than at least one video port possessed by a processor to be output from said processor through said video port, said information processing method comprising the steps of:
acquiring a multiplexed video signal which is output by said processor through said video port and which has said video signals multiplexed; and
extracting individually frame images of said video signals from a frame image which is constituted by said multiplexed video signal acquired in said acquiring step and which has a sufficiently large number of pixels so that the frame images of said video signals are being pasted on said frame image in non-overlapping relation to one another.

14. An information processing apparatus causing a larger number of video signals than at least one video port possessed by a processor to be input to said processor through said video port, said information processing apparatus comprising:
a multiplexed video frame creation section configured to create multiplexed video frames in such a manner that each of said multiplexed video frames has said video signals multiplexed therein for input to said processor through said video port and includes a sufficiently large number of pixels so that frame images represented individually by said video signals may be pasted onto each multiplexed video frame in non-overlapping relation to one another; and
a multiplexing block configured to multiplex said video signals in such a manner that the frame images represented individually by said video signals are pasted in non-overlapping relation to one another onto each of said multiplexed video frames created by said multiplexed video frame creation section.

15. An information processing apparatus causing a larger number of video signals than at least one video port possessed by a processor to be output from said processor through said video port, said information processing apparatus comprising:
an acquisition section configured to acquire a multiplexed video signal which is output by said processor through said video port and which has said video signals multiplexed therein; and
an extraction block configured to extract individually frame images of said video signals from a frame image which is constituted by said multiplexed video signal acquired by said acquisition section and which has a sufficiently large number of pixels so that the frame images of said video signals are being pasted on said frame image in non-overlapping relation to one another.
